(19) United States
(12) Patent Application Publication
(10) Pub. No.: US 2011/0197253 A1
(43) Pub. Date: Aug. 11, 2011

(54) Method and System of Responding to Buffer Overflow Vulnerabilities

(75) Inventor: Egemen Tas, Jersey City, NJ (US)

(73) Assignee: Comodo Security Solutions, Inc.

(21) Appl. No.: 12/701,752

(22) Filed: Feb. 8, 2010

(51) Int. Cl. G06F 21/00; G06F 17/00; G06F 9/44

(52) U.S. Cl. 726/1; 717/171; 726/27; 709/224

(57) ABSTRACT

The application discloses a method of protecting a computer against buffer overflow attacks by creating a security policy based on information about the buffer overflow. This results in a dynamic and “on-the-fly” security policy that can be applied to an application to protect the computer. The application also discloses a method where the buffer overflow is reported to central server. The central server monitors the publisher to determine when a patch becomes available to remedy the problem. The server notifies the security software when a patch is available so that either the security software or computer user can download and install the patch.

### BACKGROUND

A buffer overflow vulnerability occurs when an application has a bug in its memory boundary handling process. Malicious software can utilize the type of bugs to inject code into a process and gain access to the computer. These vulnerabilities enable a large percentage of exploits in software and result in significant problems.

Detecting buffer overflow vulnerabilities and attacks is well known in the field and is the subject of numerous papers. A variety of reporting and testing tools are available on the open market to assist developers in finding and eliminating these problems. However, in practice, bugs still occur and a lot of new code still contains buffer overflow problems, making detection and prevention of these attacks a high priority for security vendors.

When a buffer overflow attack occurs, detection software will gather information about the cause of the problem, including the file path, name of the process generating the error, and type of overflow error. Usually, this information is reported to the application's developers who then create a fix for the application. However, this leaves computers with the application vulnerable to buffer overflow attacks until the patch has been created and installed. Some patches might take days to create and years to fully distribute. Often, a patch has even been created but the user lacks awareness of the patch and risks compromise out of ignorance.

Thus, there is a need for real time protection and a system for alerting users about patch fixes.

### SUMMARY OF INVENTION

The disclosed invention is a method and system for protecting against buffer overflow vulnerabilities by having security software protecting the computer create security policies based on the buffer overflow information.

An alternate embodiment, FIG. 1a, 1b, has the security software communicate with a server to check whether a patch is available that remedies the vulnerability. If a patch is available, the security software downloads and installs the patch. The server monitors vendors associated with detected buffer overflow vulnerabilities and alerts users who have reported the vulnerability when a patch is available.

The problem can also be reported to a central information server that will automatically locate and install patches when the fix becomes available.

### BRIEF DESCRIPTION OF DRAWINGS

FIG. 1 is a flowchart of one embodiment where security software creates security policies based on buffer overflow error information.

FIG. 2 is a depiction of one embodiment of the invention where the security software creates a security policy based on buffer overflow error information.

FIG. 3 is a flowchart of the embodiment where security policy is created based on buffer overflow error information and previous actions of the application.

FIG. 4 is a flowchart of one embodiment where a patch is downloaded by security software.

FIG. 5 is a flowchart of one embodiment where the publisher's website is checked for patch by security software.

FIG. 6 is a depiction of one embodiment of the invention where a patch is downloaded by security software.

### DETAILED DESCRIPTION

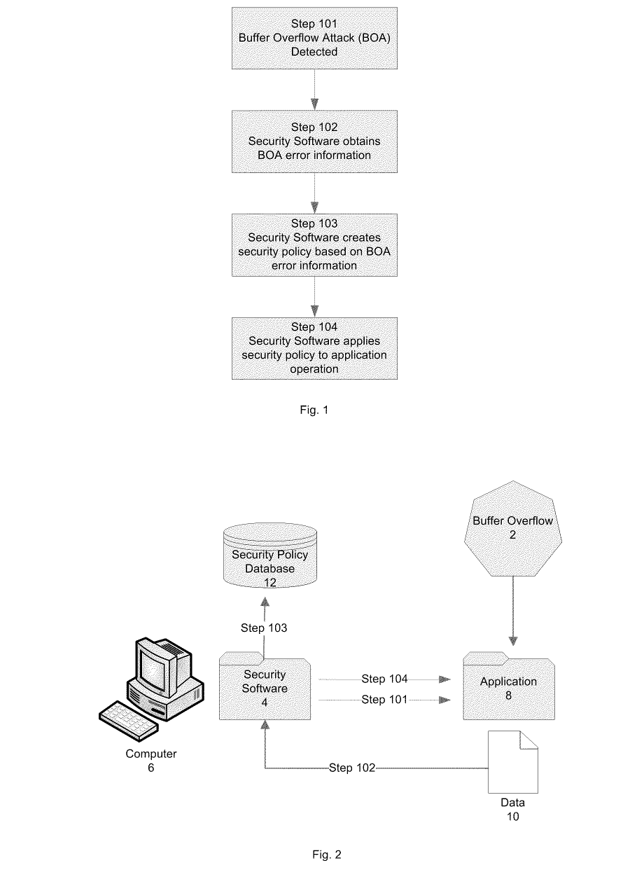

In the first embodiment of the invention, FIG. 1 and FIG. 2, security software 4 protects a computer 6 against a buffer overflow 2 by automatically creating a security policy (step 103) based on data obtained about the buffer offer attack 10. Security software can include, but is not limited to, HIPS, anti-virus programs, firewalls, memory overflow prevention systems, and other security products relying on the identification and prevention of malicious files. The reader should understand that the references to “security software” include all other security programs employing the use of the invention in preventing the operations of malicious files.

Security policies can be any rules read by security software in order to respond to or various a activities of a computer 6. All such activities are not intrinsically harmful. Examples of security policies that can be created for an application experiencing a buffer overflow attack include:

Preventing the application to connect to a website,

Preventing the application to send packets through a certain port,

Preventing the application from modifying the file system,

Preventing the application from accessing the registry, and

Preventing the application from accessing other processes in memory.

The number of different possibilities of security policies is practically limitless. The exact security policy created is based on the information obtained from the buffer overflow 2. The buffer overflow information gathered by the security software 4 is the typical information obtained by buffer overflow detection software, such as the file name, the application experiencing the buffer overflow, the type of buffer overflow, and processes related to the buffer overflow. Rules can be highly tailored based on this information or of a more general nature to prevent all processes and interactions by the application 8 experiencing a buffer overflow 2. For example, a security policy can be created preventing all access to the file system for the application 8 or different security policies can be created based on the type of buffer overflow, the process being accessed by the buffer overflow, or file path of the software encountering the buffer overflow 2.

In step 104, after the security policy is created, the security software 4 adds it to its security policy database 12 and applies the security policy to the application 8 from that point forward. The security policy can be removed from the security policy database 12 automatically after an update is downloaded that fixes the buffer overflow vulnerability. The security policy can also be removed upon restart of the application, allowing the application 8 to function as normal until another buffer overflow error is detected. In addition to the application 8 itself, the security policy can apply and be listed for each process associated with the application as identified by the security software 4 (through an internal list or via detection of such interaction in the system memory) or as identified in the data obtained about the buffer overflow error.

The security policy can be removed automatically from the security policy database 12 after an updated by checking the database each time a patch is installed. If a patch matches an application found in the security policy database 12, then the security policies associated with buffer overflow problems can be removed. For a more dynamic solution, the security software 4 can scan the patch release notes to determine whether the buffer overflow vulnerability has been addressed. The security policy is removed from the security policy database 12 only if the buffer overflow vulnerability has been addressed in the patch notes.

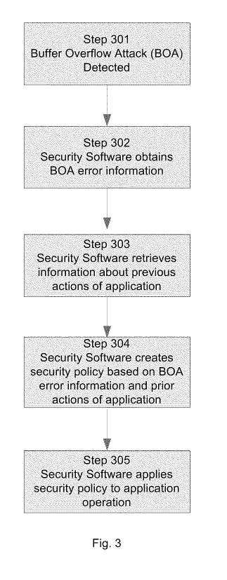

In an alternate embodiment shown in FIG. 3, the security software 4 creates the security policy based on the prior actions of the application 8. The security software 4 can monitor the application 8 prior to the buffer overflow attack occurring. The security software 4 records the files accessed and registry entries read by the process. In step 304, after encountering the buffer overflow problem, the security software 4 creates a security policy that allows the application 8 to operate within its typical defined parameters, but restricts the application from exceeding these bounds. For example, if the application routinely access file X and registry entry Y, the security policy created by the security software will continue to allow the application to access X and Y but will prevent all other registry and file access.

Creating a security policy “on the fly” allows the security software to minimize the damage an injected process can cause because a dynamic security policy can apply instantly to running software and dynamically restrict access of any injected process. Quick security policy creations that last only until the software is restarted allow a user to keep using the application without fear of a malicious process running in the background.

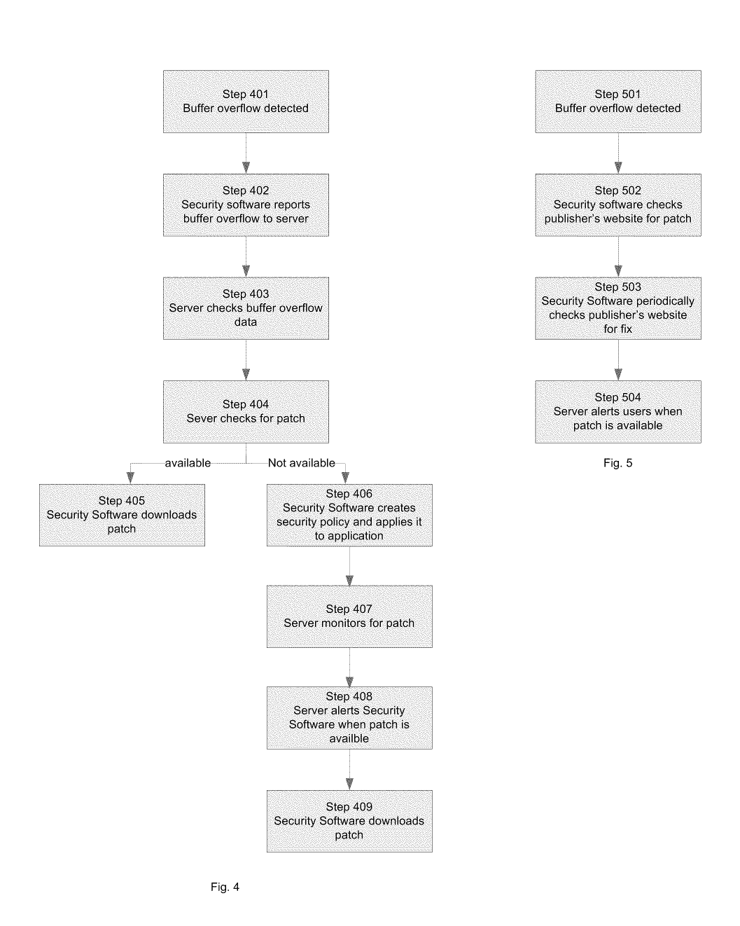

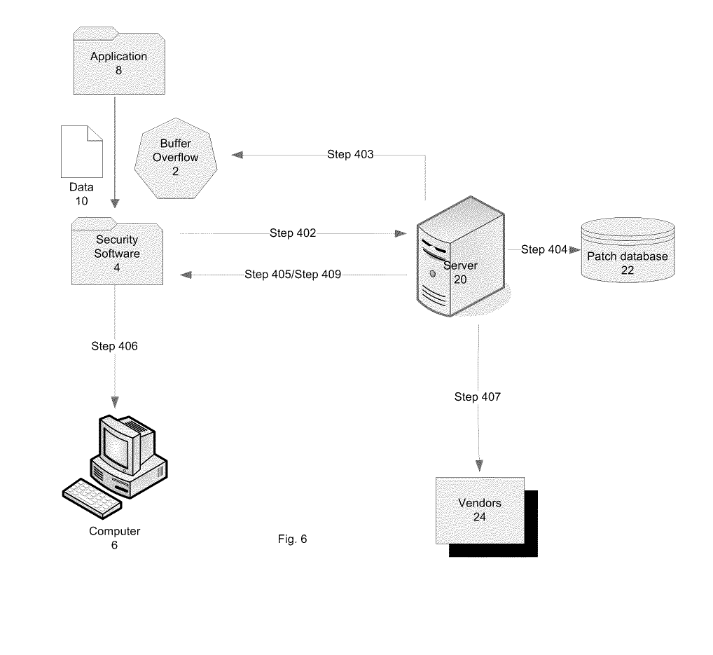

In a third embodiment, shown in FIG. 4, the security software 4 reports the buffer overflow to a server 20 (step 402). In step 403, the server 20 checks the buffer overflow information 10 to identify the application, publisher, and type of buffer overflow. In step 404, the server 20 checks a database of patches 22 to see if a fix has been created that remedies the buffer overflow error 2. The patch database 22 can contain the patches or simply list the publisher 24 and where the patch is located on the web. Alternatively, as shown in FIG. 5, instead of a database of patches, the server or security software can check the website of the application's publisher to determine whether a fix is available.

If a patch for the buffer overflow error 2 is listed in the server's database 22 or if a patch is found on the publisher's 24 website, in step 405, the security software 4 downloads and installs the patch. If a patch is not available, in step 406, the security software 4 creates a security policy as in the first embodiment, and applies that security policy to the application to restrict the potential damage caused by a buffer overflow exploit.

If a patch is not available, then, in step 407, the server can monitor the publisher's 24 website for a patch and alert the security software as soon as the patch is available. At that point, in step 409, the security software 4 will download and update the patch.

Alternatively, the security software 4 can check the server 20 periodically to determine whether a patch has been added to the database. If a patch is found, the security software 4 will alert the user and update the application 8. The security software can check the availability of the patch every day, every week, or any other time frame as either set in the security software or as selected by the user.

The server 20 can also maintain a list of users who have encountered the buffer overflow vulnerability 2. The server 20 monitors the website of each publisher (or vendor) 24 that has an application with reported buffer overflow vulnerabilities to see if a patch is available. This information can be compiled by having security software running on the various computers report to the server each publisher and the associated software experiencing a buffer overflow error.

Once a patch is detected, the server 20 reports back to all security software 4 that detected the vulnerability, allowing the security software 4 or user to download and install the patch as soon as it becomes available. The security software will then remove the rule that was created based on the detected buffer overflow vulnerability.

The invention is not restricted to the details of the foregoing embodiments. The invention extend to any novel one, or any novel combination, of the features disclosed in this specification (including any accompanying claims, abstract and drawings), or to any novel one, or any novel combination, of the steps of any method or process so disclosed.

What is claimed is:

1. A method of responding to a buffer overflow comprising:
a. Creating a security policy based on information obtained from a buffer overflow and
b. Applying the security policy to the application causing the buffer overflow

2. A method according to claim 1, where the security policy restricts access to the file system for the application causing the buffer overflow.

3. A method according to claim 1, where the security policy is created by security software protecting a computer where the buffer overflow occurred.

4. A method according to claim 1, where the security policy is created by the security software based on the prior actions of the application causing the buffer overflow.

5. A method according to claim 4 where the application causing the buffer overflow is restricted from accessing files not previously accessed.

6. A method according to claim 5 where the application causing the buffer overflow is restricted from accessing registry entries not previously accessed.

7. A method according to claim 1 where the security policy is removed after a patch for the application causing the buffer overflow is installed.

8. A method according to claim 7 where the security policy is removed only if the patch information states that the patch corrects the buffer overflow.

9. A method of responding to a buffer overflow comprising:
a. Sending information about a buffer overflow to a server,
b. Checking a database to determine if a patch exists for the application causing the buffer overflow,

10. A method according to claim 9, further comprising creating a security policy if a patch does not exist.

11. A method according to claim 9, further comprising having a patch installed for the application causing the buffer overflow.

12. A method according to claim 9, further comprising having the server monitor a website associated with the application causing the buffer overflow.

13. A method according to claim 12, where security software is alerted when a patch becomes available.

14. A method according to claim 12, where the server maintains a list of computers that have reported a buffer overflow.

15. A method according to claim 9, further comprising having security software protecting a computer that experienced the buffer overflow monitor a website associated with the application causing the buffer overflow.

16. further comprising having the server monitor a website associated with the application causing the buffer overflow.

17. application's publisher's website patch installed for the application causing the buffer overflow.

18. A system of responding to a buffer overflow vulnerability comprising:
a. Security software protecting a computer that experienced a buffer overflow problem
b. A server
c. A database of patches
d. Means of a applying a patch after the server receives information about a buffer overflow vulnerability from the security software.

19. A system according to claim 18, further comprising means of communicating with a website associated with an application that caused a buffer.
